(19) United States
(12) Patent Application Publication
(10) Pub. No.: US 2022/0088632 A1
(43) Pub. Date: Mar. 24, 2022

(54) APPLICATOR WITH AT LEAST ONE PUMP HAVING THERMAL BARRIER AND ACTIVE COOLING

(71) Applicant: NORDSON CORPORATION, Westlake, OH (US)

(72) Inventor: Joel E. Saine, Dahlonega, GA (US)

(21) Appl. No.: 17/025,368

(22) Filed: Sep. 18, 2020

(51) Int. Cl. B05C 5/00; B05C 11/10; B05C 5/02

(52) U.S. Cl. CPC B05C 5/001; B05C 5/02; B05C 11/1044; B05C 11/1042

(57) ABSTRACT

In one example, a pump assembly configured to connect to a manifold of an applicator includes a pump, a drive motor unit, and a thermal isolation region. The drive motor unit includes an output drive shaft connected to the pump and a drive motor configured to rotate the output drive shaft about a drive axis. The thermal isolation region is between the pump and the drive motor. The thermal isolation region includes an isolation plate and a thermal isolation frame. In one example, a cooling sleeve surrounds a proximal end portion of the drive motor unit so as to define an air flow passage between the proximal end portion of the drive motor unit and an inner surface of the cooling sleeve. In one example, the pump assembly further includes a coupling operatively connecting the pump and the drive shaft, the coupling including an insulating element therein.

### TECHNICAL FIELD

The present disclosure relates to applicators and methods for the dispensing of various materials such as adhesives, in particular, to pump assemblies and methods for pumping materials in applicators.

### BACKGROUND

Typical adhesive applicators for applying hot-melt adhesive onto a substrate contain multiple positive-displacement gear pumps connected to a unitary manifold or segmented manifold (hereafter referred to as a manifold). Multiple modules, each including a nozzle, are applied across the face the manifold as is well known in the industry. These gear pumps have a common drive shaft to turn all the pumps to dispense adhesive. A common drive shaft provides the means to turn the pumps. However, a common drive shaft configuration has drawbacks.

For example, when all of the pumps are the same size, all of the pumps operate at the same speed (rpm) resulting in uniform flow rates from each pump. Furthermore, it is time consuming to change/replace a pump if defective or if a different size is needed, as the common drive shaft and motor must first be removed from the applicator.

In typical applicators, the flow paths between the pumps and the manifolds are somewhat fixed. This, in turn, eliminates the ability to adjust or change adhesive flow streams across the width of the applicator. Furthermore, typical applicators using the pumps described above are considered metered type applicators. However, applicators may be pressure fed. But typical applicators do not include combination of metered feeds and pressure feeds in single applicator design.

In typical liquid adhesive applicators, heat is applied to melt the adhesive. The application of such heat may disadvantageously degrade or otherwise lessen the useful life of the motor or gearbox. It would therefore be desirable to provide a pump assembly having a thermal dissipation zone to reduce or otherwise dissipate the heat that is applied or otherwise exists in proximity to the motor, gear pump, and/or gearbox. It would further be desirable to provide such a pump assembly with a compact design to facilitate a motor drive system for gear pumps.

### SUMMARY

Described herein are pump assemblies configured to connect to a manifold of an applicator.

In an example, a pump assembly configured to connect to a manifold of an applicator comprises a pump, a drive motor unit, and a thermal isolation region. The drive motor unit includes an output drive shaft connected to the pump. The drive motor unit includes a drive motor configured to rotate the output drive shaft about a drive axis. The thermal isolation region is between the pump and the drive motor. The thermal isolation region includes an isolation plate and a thermal isolation frame. The isolation plate is formed from a thermally insulating material. The thermal isolation frame has a first end and a second end offset from one another along the drive axis. The thermal isolation frame defines a hollow interior between the first and second ends. The hollow interior is configured to permit airflow between the first and second ends.

In another example, a pump assembly configured to connect to a manifold of an applicator comprises a pump, a drive motor unit, and a cooling sleeve. The drive motor unit includes an output drive shaft connected to the pump. The drive motor unit includes a drive motor configured to rotate the output drive shaft. The cooling sleeve surrounds a proximal end portion of the drive motor unit. An air flow passage is defined between the proximal end portion of the drive motor unit and an inner surface of the cooling sleeve.

In a further example, a pump assembly configured to connect to a manifold of an applicator comprises a pump, a drive motor unit, and a coupling. The drive motor unit includes an output drive shaft. The drive motor unit includes a drive motor configured to rotate the output drive shaft. The coupling operatively connects the pump and the output gear shaft. The coupling includes at least one insulating element therein.

Another example is an applicator comprising a manifold, a dispensing module, and a pump assembly as described herein. The dispensing module is coupled to the manifold. The pump assembly is configured to removably couple to the manifold.

### BRIEF DESCRIPTION OF THE DRAWINGS

The following description of the illustrative examples may be better understood when read in conjunction with the appended drawings. It is understood that potential examples of the disclosed systems and methods are not limited to those depicted.

FIG. 1 shows a front perspective view of an applicator according to one example;

FIG. 2 shows a top view of the applicator of FIG. 1 according to one example;

FIG. 3 shows a rear view of the applicator of FIG. 1 according to one example;

FIG. 4 shows a side view of the applicator of FIG. 1 according to one example;

FIG. 5 shows a rear perspective view of a pump assembly removed from the applicator of FIG. 1 according to one example;

FIG. 6 shows a front perspective view of a pump assembly of the applicator of FIG. 5 according to one example;

FIG. 7 shows a rear perspective view of the pump assembly of FIG. 6 according to one example;

FIG. 8 shows a partially exploded view of the pump assembly of FIG. 6 according to one example;

FIG. 9 shows a cross-sectional view of a portion of the pump assembly of FIG. 6 according to one example;

FIG. 10 shows another cross-sectional view of a portion of the pump assembly of FIG. 6 with the drive motor unit removed to show additional details according to one example;

FIG. 11 shows a computer model of air flow through a cooling sleeve of the pump assembly of FIG. 6 according to one example;

FIG. 12A shows a perspective view of a coupling of the pump assembly of FIG. 6 according to one example;

FIG. 12B shows an exploded view of the coupling of FIG. 12A according to one example;

FIG. 13 shows a schematic block diagram of a control system configured to operation of a drive motor unit of the pump assembly of FIG. 6 according to one example;

FIG. 14 shows a cross-sectional view of the pump assembly of FIG. 6 showing a gear assembly according to one example;

FIG. 15 shows a perspective view of the gear assembly of FIG. 14.

### DETAILED DESCRIPTION

In the following detailed description, reference is made to the accompanying drawings, which form a part hereof. In the drawings, similar symbols identify similar components, unless context dictates otherwise. The illustrative examples described in the detailed description and drawings are not meant to be limiting and are for explanatory purposes. Other examples may be utilized, and other changes may be made, without departing from the spirit or scope of the subject matter presented herein. It will be readily understood that the aspects of the present disclosure, as generally described herein and illustrated in the drawings, may be arranged, substituted, combined, and designed in a wide variety of different configurations, each of which are explicitly contemplated and form a part of this disclosure.

While conventional pump assemblies, applicators, and dispensing systems have been adequate for their intended purpose, there is a need for a pump assembly that minimizes thermal transfer between the components. Such pump assemblies may advantageously minimize thermal transfer from the pump surface and/or minimize thermal transfer through the output drive shaft. Such pump assemblies may employ an active cooling mechanism to assist in minimizing thermal transfer.

The pump assemblies and applicators of the present disclosure can be used in a variety of applications as will be readily appreciated by those skilled in the art. By way of non-limiting example, it is contemplated that the foregoing may be used in a dispensing system for dispensing an adhesive (e.g., a hotmelt adhesive) onto a substrate.

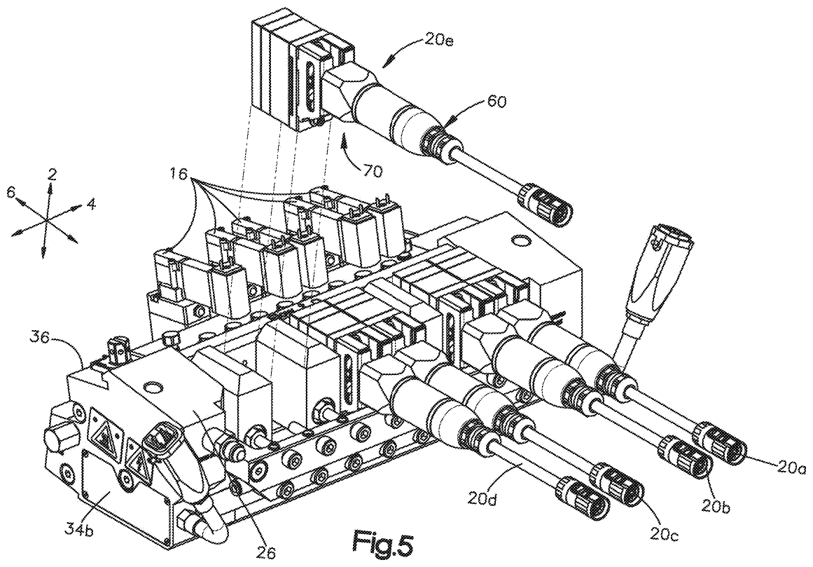

Referring first to FIG. 5, a pump assembly 20e can be seen removed from an applicator. The pump assembly 20e may generally be configured to connect to a manifold 12 of the applicator 10. The pump assembly generally includes a pump 20, a drive motor unit 60, and a thermal isolation region 70. As will be described in detail herein, the thermal isolation region 70 is generally configured to reduce or minimize thermal transfer and/or increase or maximize thermal dissipation between the pump 20 and the drive motor unit 60. This may advantageously reduce or minimize burn out of the drive motor unit, thereby increasing the life expectancy and/or predictable service of the drive motor unit. As will be described herein, the thermal isolation region may include one or more components configured to assist in the aforementioned thermal transfer and/or thermal dissipation. In examples, the thermal isolation region includes a thermal isolation plate, an active cooling mechanism (e.g., a cooling sleeve), and/or a coupling. It should be understood that the applicator can be metered, pressure-fed, and multi-zone pressure-fed, including in a single manifold as desired to suit a particular application.

In certain examples, the applicator 10 may be a hybrid applicator. The hybrid applicator may be configured for dispensing adhesive (e.g., a hotmelt). The hybrid applicator may be configured for both metered output and pressure-fed output. In examples, the hybrid applicator may include at least one pump assembly as described herein and at least one pressure feed block, although it is to be understood that the hybrid applicator may include any number of pump assemblies and pressure feed blocks to suit a particular application. The at least one pump assembly and the at least one pressure feed block may each be coupled to the manifold of the hybrid applicator. The pressure feed block(s) of the hybrid applicator may be configured to receive adhesive from a melting unit located upstream of the pressure feed block. A pump positioned near the melting unit may be used to feed the adhesive (e.g., via hoses) to an input of the pressure feed block. Heat from the manifold may be transferred to the pressure feed block, thereby heating the adhesive within the pressure feed block. Combining at least one pump assembly with a pressure feed block may advantageously increase process flexibility to the applicator. By way of non-limiting example, the at least one pump assembly may permit precise metering of adhesive streams from the dispensing module, while other adhesive streams are associated with the less precise pressure feed block.

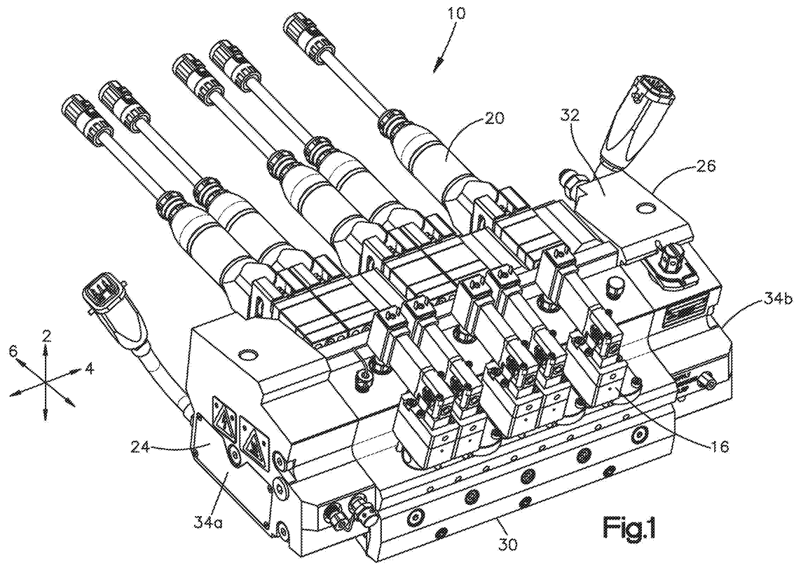

Referring now to FIGS. 1-4, an example applicator 10 is shown. In examples as described herein, the applicator may be configured for dispensing an adhesive (e.g., a hotmelt). More specifically, the applicator may be configured for dispensing a hotmelt adhesive onto a substrate, such as for the manufacture of personal hygiene products (e.g., diapers). As may be seen with reference to FIGS. 1-4, the applicator may generally include a manifold 12, at least one dispensing module 16, and at least one pump assembly 20. The dispensing module 16 may, in certain examples, be coupled to the manifold. The at least one pump assembly 20 may be removably mounted to the manifold 12. In certain examples, the at least one pump assembly 20 may be slidably received within the manifold 12 and removably mounted thereto by fasteners. The manifold 12 may, in certain examples, further include at least one air control valve 18 coupled thereto. The manifold 12 may further include a pair of end plates 24, 26 on either side of the manifold 12. The manifold 12 may define a plurality of manifold segments 22. In examples in which the manifold 12 defines a plurality of manifold segments 22, the manifold segments 22 may be disposed between the end plates 24, 26. In alternative embodiments, the manifold 12 may be a unitary manifold. The applicator 10 may include one or more nozzles (not shown) through which adhesive (e.g., a hotmelt) may be ejected or otherwise dispensed. The nozzle(s) may be a spray nozzle or a coating nozzle, although examples of the disclosure are not so limited.

In some examples, the applicator 10 may include a plurality of dispensing modules 16, a plurality of manifold segments 22, and/or a plurality of pump assemblies 20, which may, for example, be arranged in a side-by-side relationship to increase the processing width of the applicator 10. As illustrated in FIGS. 1-4, for example, the applicator 10 includes five pump assemblies 20a, 20b, 20c, 20d, and 20e. Although the applicator 10 is illustrated as including five pump assemblies 20a-e, examples of the disclosure are not so limited. Rather, as will be appreciated by those skilled in the art, the applicator 10 may generally be used in a wide variety of applications and is not limited to use with multiple or any specific number of dispensing modules 16, manifold segments 22, and/or pump assemblies 20 and may be readily adapted to suit a particular application. By way of non-limiting example, the applicator 10 may include a single pump assembly, two pump assemblies, three pump assemblies, four pump assemblies, five pump assemblies, or more than five pump assemblies.

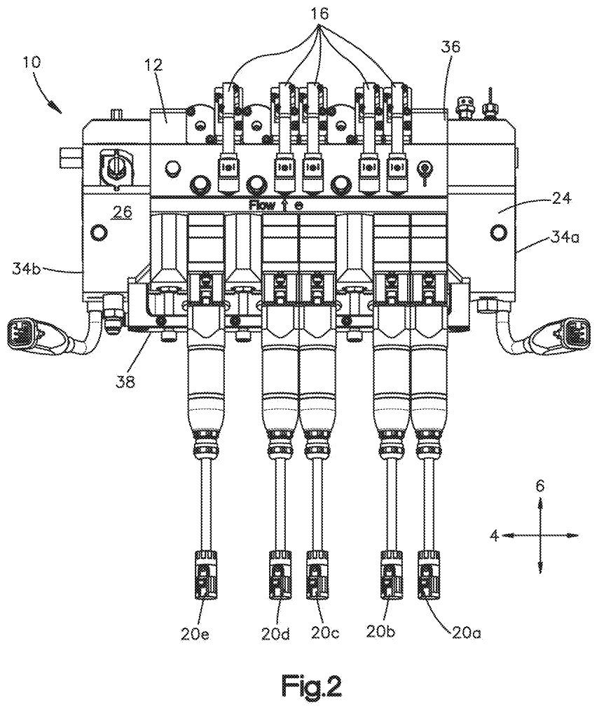

Accordingly, in examples, the applicator 10 may include a plurality of dispensing modules 16 and a plurality of pump assemblies 20. In such embodiments, each pump assembly 20 may be associated with one dispensing module 16 (e.g., by being coupled thereto). Put another way, in examples, the number of dispensing modules 16 may correspond directly to the number of pump assemblies 20. Each dispensing module 16 may, in certain examples, be associated with one manifold segment 22 (e.g., by being coupled thereto). However, in alternative examples, two or more pump assemblies and/or two or more dispensing modules may be associated with a single manifold segment (e.g., by being coupled thereto), such as is illustrated in FIG. 2.

With continued reference to FIGS. 1-4, the manifold 12 may include a base 30 and a top 32. The top 32 may be spaced apart from the base 30 along a first direction 2. The manifold 12 may also include a first side 34a and an opposite second side 34b. The second side 34b may be spaced apart from the first side 34a along a second direction 4. The second direction 4 may generally be perpendicular to the vertical direction 2. In examples, the first side 34a may lie within a first plane P1, and the second side 34b may lie within a second plane P2. The second plane P2 may be substantially parallel to the first plane P1. In alternative examples, the first plane P1 and the second plane P2 may not be parallel to one another, such that the first side 34a and the second side 34b are angled with respect to one another. The manifold 12 may also include a front 36 and a back 38. The back 38 may be spaced apart from the front 36 along a third direction 6. The third direction 6 may generally be perpendicular to the first direction 2 and the second direction 4. The first side 34a and the second side 34b may extend from the front 36 of the manifold 12 to the back 38 thereof. The first side 34a and the second side 34b may also extend from the base 30 of the manifold 12 to the top 32 thereof. In examples, the third direction 6 may be referred to as the machine direction, and the second direction may be referred to as the cross-machine direction. As will be appreciated, the directional components described above may also apply generally to components of the applicator 10.

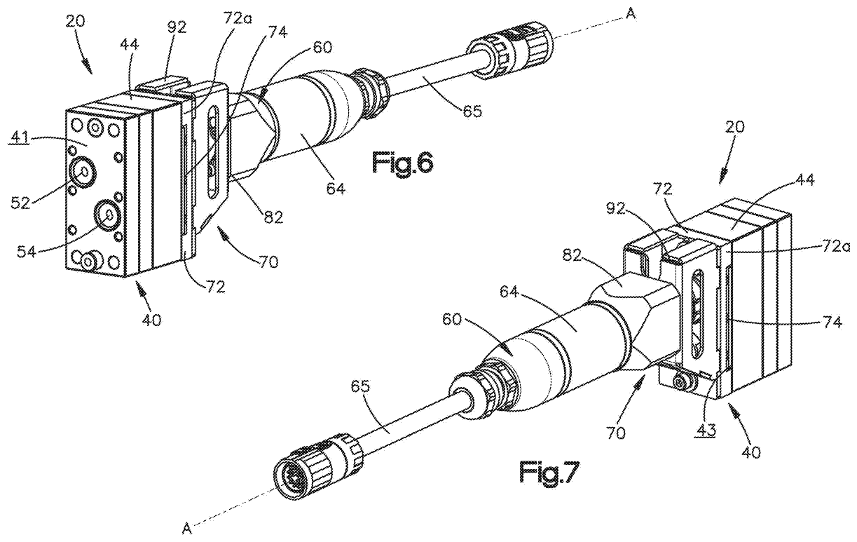

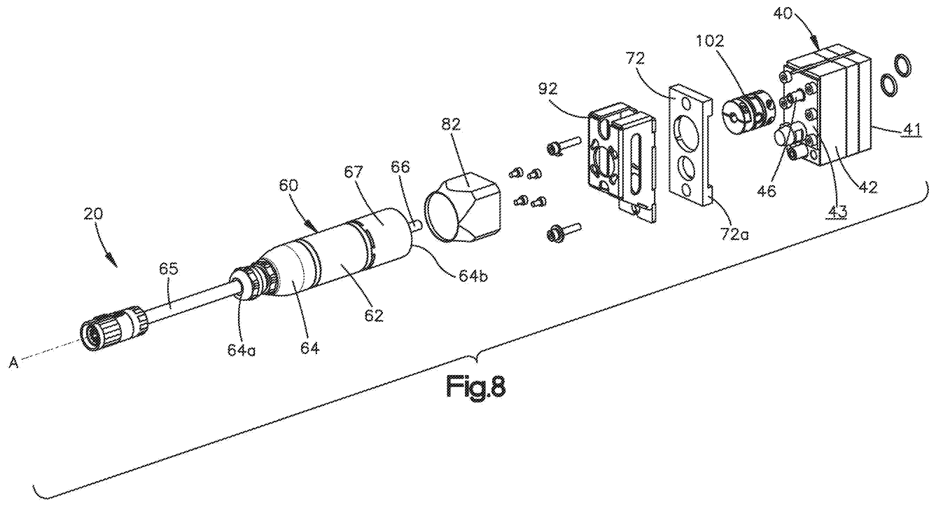

Turning to FIGS. 6-10, an example pump assembly 20 is shown. For clarity, a single pump assembly 20 is described below, and it will be understood that pump assembly 20 can be used to implement one or more, up to all, of pump assemblies 20a-20e in FIG. 5. As described herein, the pump assembly 20 is generally configured to connect to a manifold of an applicator, such as to connect to manifold 12 of applicator 10 illustrated in FIGS. 1-5. The pump assembly 20 may also generally be configured to supply heated adhesive to the manifold 12. The pump assembly 20 may be configured to supply heated adhesive to the manifold 12 at a given volumetric flow (or flow rate), which may be tuned as desired to suit a particular application. As described herein and as will be appreciated by those skilled in the art, the pump assemblies described herein may be utilized with a wide variety of applicators and are not limited to use with the exemplary applicator shown in FIGS. 1-5.

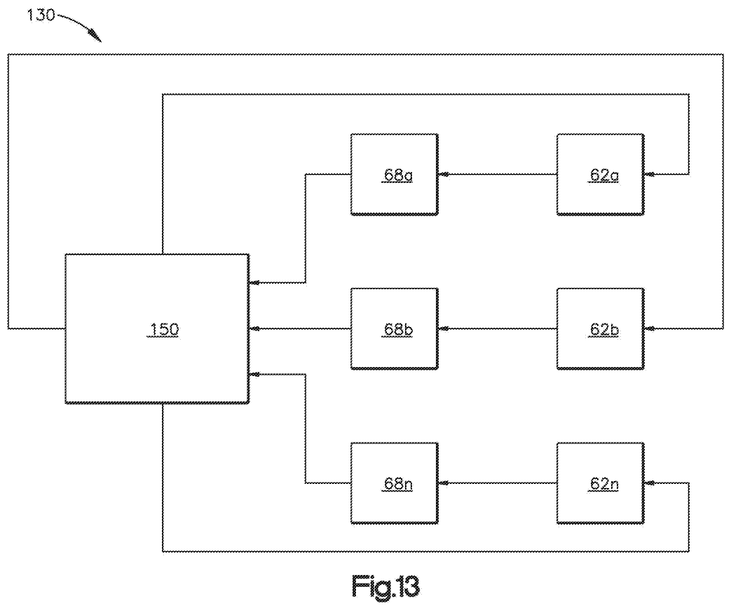

The pump assembly 20 includes a drive motor unit 60 and a pump 40. The drive motor unit 60 can be a servo motor or any other suitable type of motor. The drive motor unit 60 is generally configured to power the pump 40. In examples, the pump 40 of each pump assembly 20a-e has its own dedicated drive motor unit 60. In such examples, because each pump 40 has a dedicated drive motor unit 60, each pump assembly 20 may be independently controlled. In examples, each pump assembly 20 may be independently controlled by an operator and/or a control system 130 (shown in FIG. 13), as described herein. In examples, the pump assembly 50 may include a gear reducer 67.

The pump housing 42 may include a proximal end wall 43 and a distal end wall 41. The distal end wall 41 may be spaced apart from the proximal end wall 43 along a first direction. In the example illustrated in FIG. 6, the distal end wall 41 of the pump housing 42 defines an inlet 52 and an outlet 54, although examples of the disclosure are not so limited. The inlet 52 of the pump housing 42 may be configured to receive liquid, such as an adhesive (e.g., a hotmelt), from the manifold 12. The outlet 54 of the pump housing 42 may be configured to discharge liquid, such as an adhesive (e.g., a hotmelt), to the manifold 12.

The drive motor unit 60 includes an output drive shaft 66 and a drive motor 62. The drive motor 62 may generally be configured to rotate the output drive shaft 66. The output drive shaft 66 may rotate about a drive axis A. The drive motor unit 60 may transfer rotational motion from the output drive shaft 66 to an input drive shaft of the pump to attain a desired pump rotational speed. The drive motor unit 60 may have a motor housing 64. The motor housing 64 may have a first end 64a and a second end 64b that are offset from one another along an axial direction. The drive axis A extends along the axial direction. The motor housing 64 may extend along the axial direction between the first end 64a and the second end 64b. The drive motor 62 may be disposed in the motor housing 64. In one example, the motor housing 64 is elongate along the axial direction. The output drive shaft 66 may extend from the second end 64b of the motor housing 64 along the axial direction. In one example, the output drive shaft 66 does not extend from the first end 64a of the motor housing 64, although the output drive shaft 66 could extend form the first end 64a of the motor housing 64 in alternative examples. In examples, the drive motor unit 60 may include a strain relief 64a for the motor cable and/or other electrical components.

The drive motor unit 60 may, in certain examples, further include one or more connectors 65, such as wires, that connect the drive motor unit 60 to a power source (not shown). The one or more connectors 65 may further connect the drive motor unit 60 with a control unit 150 having a control system 130 (shown in FIG. 13) for controlling the drive motor unit 60. In examples, the drive motor unit 60 may further include a rotational sensor (68) that is electrically connected to the control unit 150. The one or more connectors 65 may extend from the first end 64a of the motor housing 64, or from another side or end of the motor housing 64.

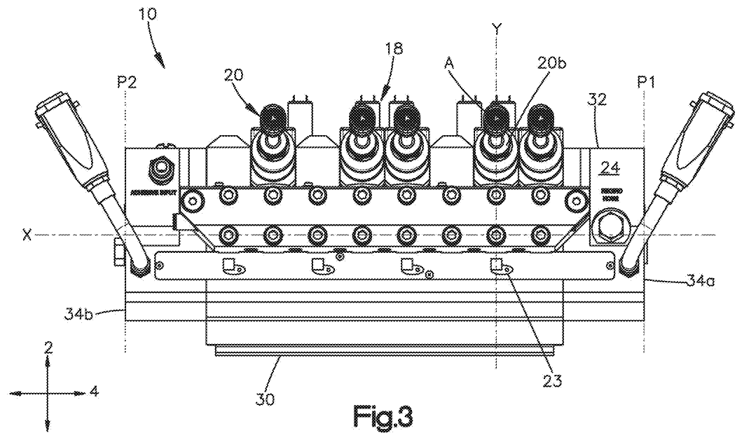

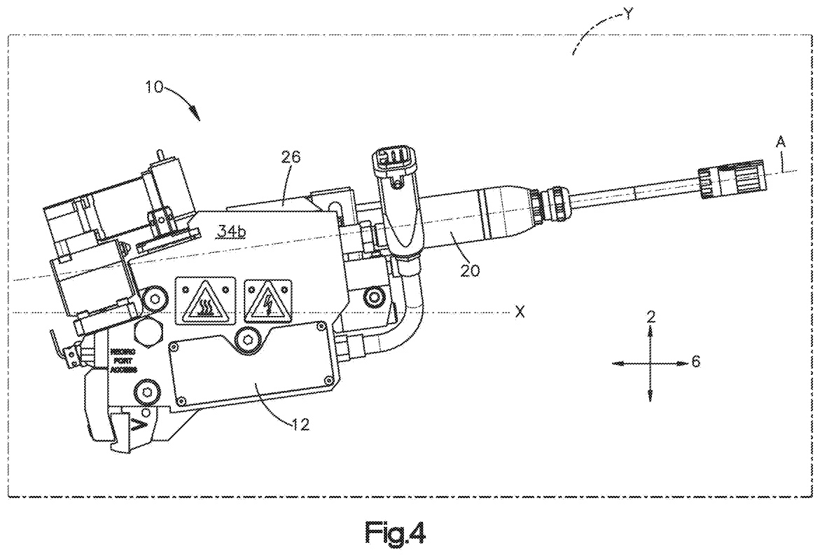

Continuing with FIG. 6 with reference back to FIG. 3 and FIG. 4, the at least one pump assembly 20 may be mounted to the manifold 12 in any of a number of different configurations. Desirably, the at least one pump assembly 20 is configured to removably couple to the manifold 12.

In one example, the at least one pump assembly 20 may be mounted to the manifold 12 such that the distal end wall 41 of the pump assembly 20 faces the manifold 12. In this example, the inlet 52 and the outlet 54 of the pump assembly 20 can be oriented in a direction parallel to the drive axis A. Further, in this example, the drive axis A intersects the distal end wall 41 of the pump assembly 20, and also intersects the manifold 12 at a location that is spaced apart from and located between each of the first side 34a and the second side 34b of the applicator 10. Put another way, in this example, the drive axis A does not intersect the first 34a or the second side 34b of the applicator 10. Rather, as may be seen in FIG. 3, the pump assembly 20b of this example is mounted to the manifold 12 such that the drive axis A lies in a plane Y that is substantially parallel to the first plane P1 (within which the first side 34a of the applicator 10 lies) and the second plane P2 (within which the second side 34b of the applicator lies). In this way, each pump assembly may have a respective drive axis that lies within a respective plane that is substantially parallel to the first plane P1 and the second plane P2 and that does not intersect the first side 34a or the second side 34b of the applicator 10. It should be appreciated that this is merely one example and that other examples of the disclosure are not so limited.

In an alternative, non-depicted example, the at least one pump assembly 20 may be mounted to the manifold 12 such that a side wall 44 of the pump assembly 20 faces the manifold 12. The side wall 44 may be perpendicular to the distal end wall 41 and the proximal end wall 43. In this example, the inlet 52 and the outlet 54 of the pump assembly 20 are oriented in a direction perpendicular to the drive axis A. Additionally, the at least one pump assembly 20 may be mounted to the manifold 12 such that the drive axis A is angularly offset with respect to plane X and is substantially parallel to plane Y. Further, in this example, the drive axis A intersects the manifold 12 at a location that is spaced apart from and located between each of the first side 34a and the second side 34b of the applicator 10. Put another way, in this example, the drive axis A does not intersect the first 34a or the second side 34b of the applicator 10. Rather, the at least one pump assembly 20 of this alternative example is mounted to the manifold 12 such that the drive axis A lies in a plane Y that is substantially parallel to the first plane P1 (within which the first side 34a of the applicator 10 lies) and the second plane P2 (within which the second side 34b of the applicator lies). In this way, each pump assembly may have a respective drive axis that lies within a respective plane that is substantially parallel to the first plane P1 and the second plane P2 and that does not intersect the first side 34a or the second side 34b of the applicator 10. It should be appreciated that this is merely one example and that other examples of the disclosure are not so limited.

With continued reference back to FIG. 3 and FIG. 4, it should be appreciated that the at least one pump assembly 20 may be mounted to the manifold 12 such that the drive axis A is oriented in any particular direction within plane Y. By way of non-limiting example, the at least one pump assembly 20 may be mounted to the manifold 12 such that the drive axis A lies within plane Y and is angularly offset with respect to a plane X extending along the second direction 4 and the third direction 6. For instance, as may be seen in FIG. 4, the at least one pump assembly 20 may be mounted to the manifold 12 such that the drive axis A is offset with respect to plane X by an angle θ. The angle θ may be an acute angle, an obtuse angle, or an angle greater than 180 degrees. By way of non-limiting example, the angle θ may be from about 0 to about 100 degrees, including from about 5 to about 50 degrees, including about 10 degrees.

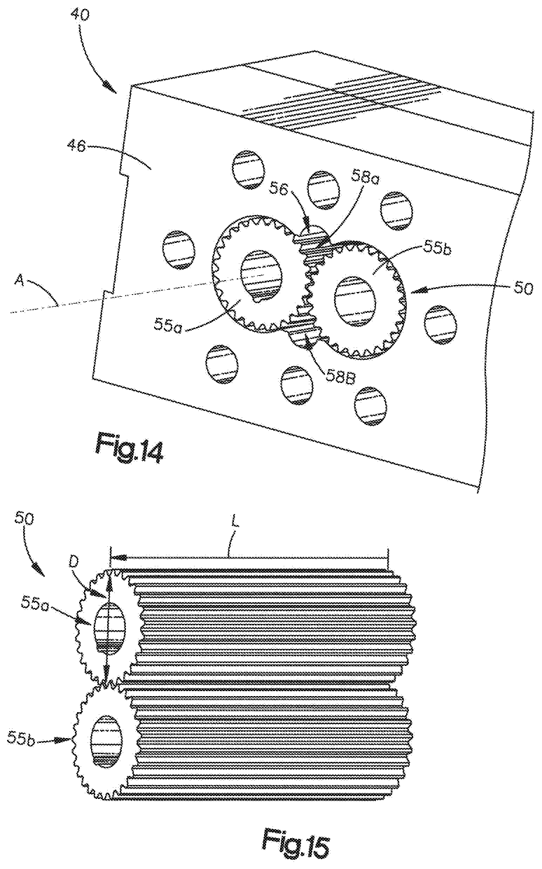

In examples, the pump assembly 20 may include one or more gear assemblies 50. The one or more gear assemblies 50 may be disposed within the pump 40 and/or the pump housing 42. The pump housing 42 may define an internal chamber 56 sized to conform generally to the profile of the gear assembly 50. In some examples, such as is illustrated in FIG. 14 and FIG. 15, the gear assembly 50 may include a driven gear 55a and an idler gear 55b. The driven gear 55a may, in certain examples, be coupled to the output drive shaft 66. In such examples, rotation of the output drive shaft 66 may rotate the driven gear 55a. Rotation of the driven gear 55a may, in turn, rotate the idler gear 55b. The driven gear 55a may rotate about an axis that is coaxial with the drive axis A. In some examples, the gear assembly 50 may include a gear shaft that is coupled to an end of the output drive shaft (e.g., via a coupling). In such examples, the gear shaft may extend into the driven gear 55a. In such examples, the gear shaft may be keyed to drive the driven gear 55a. In some examples, a seal member may be placed around the gear shaft. The seal member may be configured to facilitate sealing of the gear assembly 50. The seal member may, in certain examples, be in the form of a coating and encasement. In use, rotation of the driven gear 55a and the idler gear 55b may drive adhesive in the pump 40 from a first section 58a of the chamber 56 to a second section 58b of the chamber 56. Thereafter, the adhesive may be routed to outlet 54. In certain examples, such as is illustrated in FIG. 15, driven gear 55a and/or idler gear 55b may have a length L and a diameter D. In examples, the length L of the driven gear 55a and/or idler gear 55b may be greater than or equal to the diameter of the driven gear 55a and/or idler gear 55b. In the example illustrated in FIG. 14 and FIG. 15, gear assembly 50 includes two gears, although other examples of the disclosure are not so limited. For instance, it will be understood that pump 40 can include any number of gears in any desirable configuration to suit a particular application and/or to achieve a desired flow rate. In some examples, the pump housing 42 or at least a portion thereof may be segmented to support gear stacking. In such examples, a plurality of gear assemblies may be stacked along the input drive shaft 46 of the pump 40. In such examples, the gear assemblies can have different outputs that are combined into a single output stream. In other examples, the gear assemblies can have different outputs that can be kept separate to provide multiple output streams through additional porting in the pump housing 42 and/or the manifold 12.

In the example illustrated in FIGS. 6-10, the pump 40 comprises a pump housing 42. The drive axis A may, in certain examples, extend through the pump housing 42. In such examples, the drive motor 62 and the pump housing 42 may generally be aligned with one another along the drive axis A. The drive axis A may, in certain examples, extend along the first direction.

In certain examples, the drive motor 62 and the pump 40 (and the drive motor unit 60 and the pump housing 42 within which the same are respectively disposed) are spaced apart from one another along the drive axis A with a thermal isolation region 70 therebetween. In specific, non-limiting examples, the thermal isolation region 70 may be disposed directly between the drive motor 62 and the pump housing 42. Put another way, the pump assembly 20 may be designed such that there are no bulky parts positioned between the drive motor 62 and the pump housing 42, except for those that form the thermal isolation region 70. By way of non-limiting example, the pump assembly 20 may be designed such that there is no clutch or similar device between the drive motor 62 and the pump housing 42. In some examples, only the thermal isolation region 70 (and the thermal isolation bodies thereof, such as the thermal isolation plate 72, cooling sleeve 82, frame 92, and/or coupling 102 discussed below) is positioned between the drive motor 62 and the pump housing 42. In further examples, the output drive shaft 66 may extend through a distal end of the drive motor and into the pump housing 42 without a clutch or similar device engaging the output drive shaft 66 therebetween. These aforementioned structures advantageously provide for a compact design for the pump assembly 20, such that the pump assembly 20 that may be quickly and efficiently removed from attachment with the manifold 12. As shown in FIG. 4 and FIG. 5, the applicator 10 may be configured to facilitate removal of the at least one pump assembly 20 from the applicator 10. As may be seen in FIG. 4, the at least one pump assembly 20 may be mounted to the applicator 10 and retained in position by an elongate plate 38, although examples of the disclosure are not so limited. The elongate plate 38 may, in certain examples, be coupled to the pair of end plates 24, 26 on either side of the manifold 12. A fastener (e.g., a captive fastener) may couple the at least one pump assembly 20 to the elongate plate 38, thereby securing the at least one pump assembly 20 in position on the manifold 12. When it is desired to remove and/or replace the at least one pump assembly 20 (or multiples ones of pump assemblies 20a-e), the fastener 29 may be loosened from the elongate plate 38 and the at least one pump assembly 20 may be removed from the manifold 12. This advantageously allows the at least one pump assembly to be quickly and efficiently removed from attachment with the manifold 12 by reducing the time required to remove and/or replace the at least one pump assembly in comparison to conventional applicators.

In examples, the manifold 12 may include thermal elements 23 (shown in FIG. 3). The thermal elements 23 may be used to elevate the temperature of the manifold 12. As a result, the at least one pump assembly 20 may experience an elevated temperature. As will be readily appreciated by those skilled in the art, thermal transfer within the pump assembly 20 (e.g., from the pump 40 to the drive motor unit 60), may cause undesirable effects, such as causing the drive motor unit 60 to burn out.

The thermal isolation region 70 may generally be configured to reduce or minimize thermal transfer and/or increase or maximize thermal dissipation between the pump 40 and the drive motor unit 60. This may advantageously minimize the effect of elevated temperatures on the drive motor unit 60, such as electrical components thereof, which may reduce or minimize burn out of the drive motor unit 60.

The thermal isolation region 70 generally includes one or more thermal isolation bodies designed so as to assist with reducing or minimizing thermal transfer and/or increasing or maximizing thermal dissipation between the pump 40 and the drive motor unit 60. For example, the thermal isolation region can 70 include a thermal isolation plate 72, a cooling sleeve 82, and/or a frame 92 as illustrated in FIGS. 6-10. In examples in which each of the foregoing thermal isolation bodies are included, the frame 92 may be mounted between the thermal isolation plate 72 and the cooling sleeve 82.

The thermal isolation plate 72 may be coupled to the pump 40, namely to the pump housing 42 within which the pump 40 is disposed. One or more fasteners may couple the thermal isolation plate 72 to the pump housing 42. The fasteners may be screws, bolts, or any other suitable fasteners. The thermal isolation plate 72 may reduce, minimize, or inhibit thermal transfer from the pump 40 to the drive motor unit 60 due to the thermal isolation plate 72 eliminating direct contact between the thermal isolation plate 72 and the pump housing 42. In examples, the thermal isolation plate 72 may be made of material having a lower thermal conductivity than materials from which the pump housing 42 and/or the outer casing (not numbered) of the drive motor unit 60 are made, so as to realize the benefits of thermal reduction. For example, the thermal isolation plate 72 may be formed from a thermoplastic. By way of non-limiting example, the thermal isolation plate 72 may be made of polyether ether ketone (PEEK), polyphenylene sulfide (PPS), fiberglass, or combinations thereof. In the example illustrated in FIGS. 6-10, the thermal isolation plate 72 may be coupled directly to the pump housing 42 such that no gap is defined between the thermal isolation plate 72 and the pump housing 42. In alternative, non-depicted embodiments, the thermal isolation plate 72 may be coupled to the pump housing 42 such that a gap is defined between the thermal isolation plate 72 and the pump housing 42. Such a gap may further aid in reducing, minimizing, or inhibiting thermal transfer from the pump 40 to the drive motor unit 60. In some examples, the thermal isolation plate 72 can have an outer surface 72a and can define a gap 74 between the outer surface 72a and the pump housing 42.

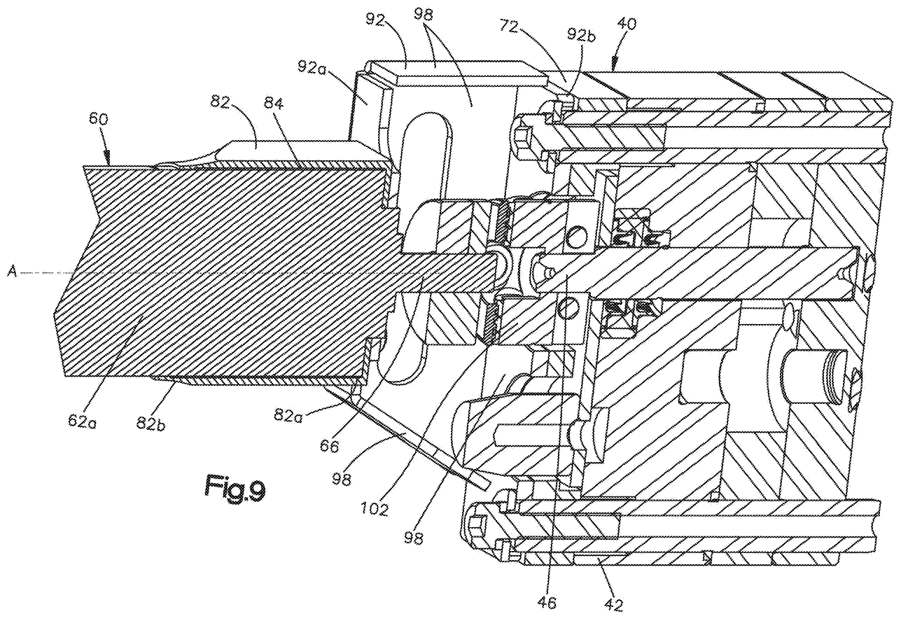

The exemplary pump assembly 20 illustrated in FIGS. 6-10 includes a cooling sleeve 82. The cooling sleeve 82 is positioned between the pump 40 and the drive motor unit 60. In examples in which the thermal isolation plate 72 is provided along with the cooling sleeve 82, the cooling sleeve 82 may be positioned between the drive motor unit 60 and the thermal isolation plate 72. The cooling sleeve 82 may have a proximal end 82a and an opposite distal end 82b. As may be seen in FIG. 9, the distal end 82b of the cooling sleeve 82 may be spaced apart from the proximal end 82a thereof along the drive axis A. In examples, the distal end 82b of the cooling sleeve 82 may be an open distal end.

The distal end 82b of the cooling sleeve 82 at least partially surrounds the drive motor unit 60 or surrounds at least a portion of the drive motor unit 60. As may be seen in FIG. 9, the distal end 82b of the cooling sleeve 82 may surround a proximal end portion 62a of the drive motor unit 60. The cooling sleeve 82 may be spaced outwardly from the proximal end portion 62a of the drive motor unit 60. In this way, an air flow passage 84 may be defined between the drive motor unit 60 and the cooling sleeve 82. In examples, the air flow passage 84 may be defined between the proximal end portion 62a of the drive motor unit 60 and an inner surface 83 (e.g., a circumferential inner surface) of the cooling sleeve 82.

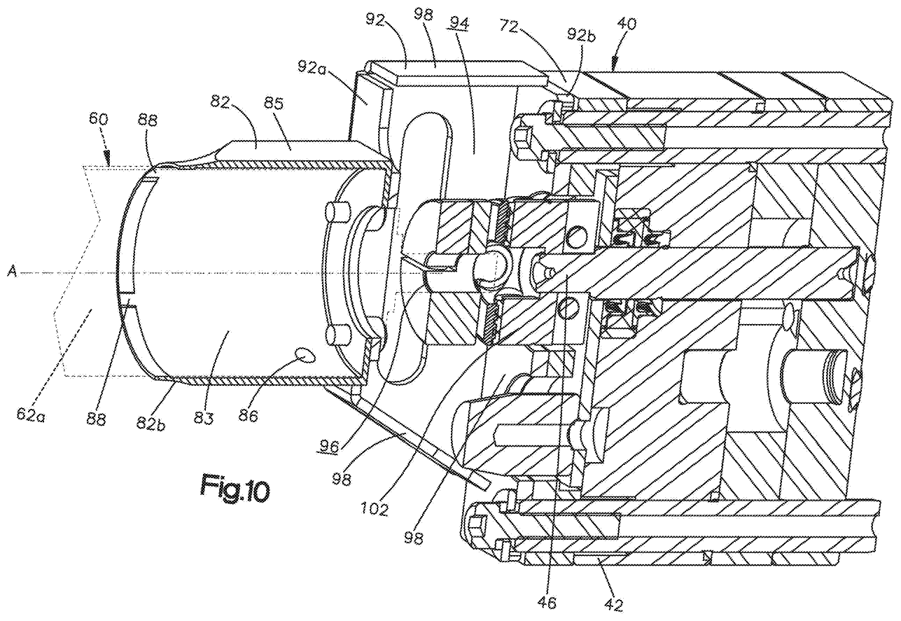

As may be seen in FIG. 10, the cooling sleeve 82 may define an air inlet 86. The air inlet 86 may be positioned proximate the proximal end 82a of the cooling sleeve 82. The air inlet 86 may be in fluid communication with the air flow passage 84. The air inlet 86 may be configured to receive air (e.g., filtered shop air) from the manifold 12 or other source. The air received via the air inlet 86 may circulate around and/or within the air flow passage 84. The air may thus circulate around the proximate end portion 62a of the drive motor unit 60. Advantageously, the circulation of air around the proximate end portion 62a of the drive motor unit 60 may provide significant convectional heat losses. Put another way, the air circulating within the air flow passage 84 and around the proximal end portion 62a of the drive motor unit 60 may assist in reducing, minimizing, or inhibiting thermal transfer from the pump 40 to the drive motor unit 60.

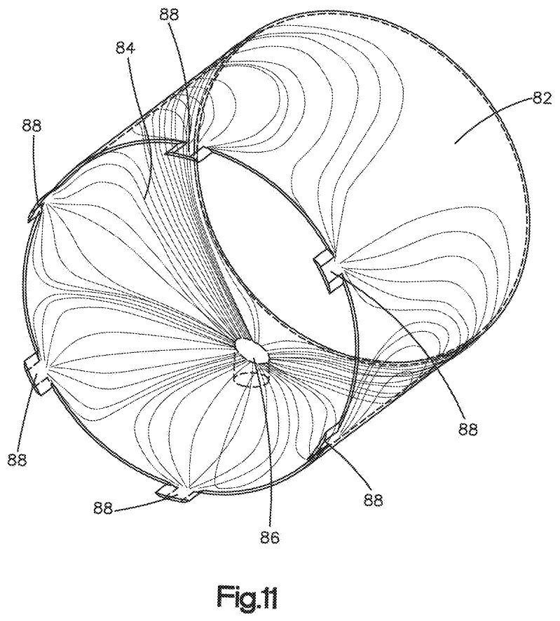

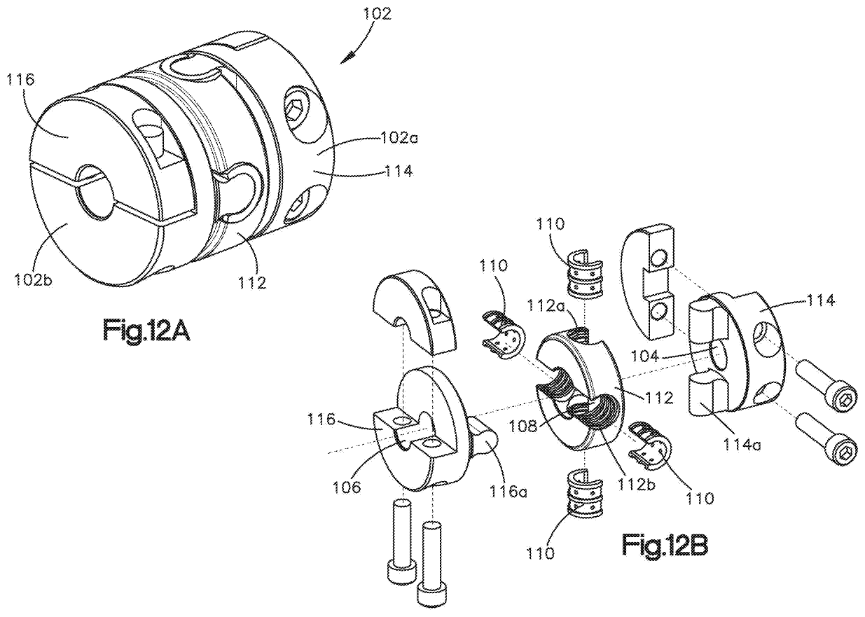

The cooling sleeve 82 may also define one or more air outlets 88. The air outlet(s) 88 may be positioned proximate the distal end 82b of the cooling sleeve 82. The one or more air outlets 88 may be in fluid communication with the air flow passage 84. The one or more air outlets 88 may be configured to discharge air from the air flow passage 84. FIG. 12 shows a computer-generated model of air flowing through the cooling sleeve 82, namely air circulating around and/or within the air flow passage 84. As may be seen, significant heat may be expelled along with the air discharged via the one or more air outlets 88. Advantageously, discharging air flow the air flow passage 84 via the one or more air outlets 88 may also assist in controlling the pressure drop and resultant flow-to-pressure ratio.

The exemplary pump assembly 20 illustrated in FIGS. 6-10 includes a frame 92. The frame 92 is positioned between the pump 40 and the drive motor unit 60. In examples in which the thermal isolation plate 72 is provided along with the frame 92, the frame 92 may be positioned between the drive motor unit 60 and the thermal isolation plate 72. In some examples, the frame 92 may be mounted to the thermal isolation plate 72, and the thermal isolation plate 72 may be mounted to the pump 40 (namely to the pump housing 42 within which the pump 40 is disposed). In other examples, the frame 92 and the thermal isolation 72 may be collectively mounted to the pump 40 (namely to the pump housing 42 within which the pump 40 is disposed). In examples in which the cooling sleeve 82 is provided along with the frame 92, the frame 92 may be positioned between the pump 40 and the cooling sleeve 82. In examples in which the thermal isolation plate 72 and the cooling sleeve 82 are both provided along with the frame 92, the frame 92 may be positioned between the cooling sleeve 82 (i.e., the proximal end 82a thereof) and the thermal isolation plate 72. In examples, the frame 92 is a metal frame. By way of non-limiting example, the frame 92 may be made of stainless steel.

The frame 92 may include a plurality of side walls 98. In examples, the side walls 98 of the frame 92 may be designed with thin cross-sections so as to minimize, reduce, or inhibit thermal transfer between the pump 40 and the drive motor unit 60. For example, one or more, up to all, of the side walls 98 may have a planar shape, such as the shape of a plate. Each of the side walls 98 of the frame 92 may have a cross-sectional dimension of from about 0.040 to about 0.10 inches, dependent upon application torque requirements. In some examples, the frame 92 may be designed to maximize surface area so as to provide significant convectional heat loss. The frame 92 may be configured to withstand torques of about 4 N·m and greater, including of from about 4 to about 5 N·m, imparted by the drive motor unit 60.

In some examples, the side walls 98 of the frame 92 may generally define a hollow interior 94 therebetween. This may advantageously assist in minimizing, reducing, or inhibiting thermal transfer through the frame 92. For instance, if the frame were instead constructed as a solid block (i.e., with no hollow interior), a significant and undesirable amount of thermal transfer could occur through the frame. In some examples, each of the side walls 98 of the frame 90 may define an air opening 96. Each of the openings 96 defined in the side walls 98 of the frame 90 may lead to the hollow interior 94. In this way, each of the air openings 96 may be configured to cause heat to be transferred out of the hollow interior 94 of the frame 92, thereby assisting in minimizing, reducing, or inhibiting thermal transfer through the frame 92. In some examples, the frame 92 may define a first end 92a and an opposite second end 92b. As may be seen in FIG. 9, the first end 92a of the frame 92 may be spaced apart from the second end 92b thereof along the drive axis A so as to define the hollow interior 94 therebetween. One or both of the first and second ends 92a and 92b may have a planar shape, such as the shape of a plate. The frame 92 may be formed from a single piece of metal that is bent to form the side walls 98 and first and second ends 92a, 92b, or the side walls 98 and ends 92a, 92b may be separate pieces that are attached to one another. The side walls 98 of the frame 92 may extend between the first and second ends 92a, 92b. For example, the side walls 98 of the frame 92 may extend from the first end 92a to the second end 92b. The first end 92a of the frame 92 may function as the surface against which the cooling sleeve 82 abuts. The second end 92b of the frame 92 may function as the surface against which the thermal isolation plate 72 abuts. Generally, as the distance between the first and second ends 92a, 92b is increased, the amount of heat that can be dissipated by the frame 92 likewise increases. However, if the distance between the first and second end 92a, 92b is too large, the structural integrity of the frame 92 may become comprised as the frame 92 may generally become incapable of withstanding torque unless a thicker metal is used. However, use of thicker materials increases thermal conductivity between the pump and the drive motor 62. In some examples, the distance between the first and second ends 92a, 92b of the frame 92 is from about 0.7 to about 2.5 or more inches, with higher application temperatures generally requiring extended distances.

One or more fasteners may couple the thermal isolation plate 72 to the pump 40 and/or the pump housing 42. One or more fasteners may couple the frame 92 to the pump 40 and/or the pump housing 42. In some examples, the one or more fasteners coupling the frame 92 to the pump 40 and/or the pump housing 42 may pass through the thermal isolation plate 72, thereby sandwiching the thermal isolation plate between the frame 92 and the pump 40 and/or pump housing 42. One or more fasteners may couple the frame 92 to the cooling sleeve 82. The fasteners may be screws, bolts, or any other suitable fasteners.

As may be seen in FIG. 9, the output drive shaft 66 may extend through the proximal end 82a of the cooling sleeve 82. The output drive shaft 66 may extend through the first end 92a of the frame 92 and into the frame 92. In some examples, as described herein, the output drive shaft 66 may extend into the coupling 102. In such examples, the coupling 102 may be at least partially disposed within the frame 92 such that the output drive shaft 66 extends into the coupling 102 within the frame 92. In alternative examples, the output drive shaft 66 may extend into the first end 92a of the frame 92 and out of the second end 92b of the frame 92. In such alternative examples, the output drive shaft 66 may extend into the pump 40. In such alternative examples in which the output drive shaft 66 extends into the pump 40, the coupling 102 and/or the input drive shaft 46 may be omitted.

Turning now to FIG. 12A and FIG. 12B, additional details and features of the coupling 102 may be seen. The coupling 102 may have a proximal end 102a and an opposite distal end 102b. As may be seen in FIG. 9, when the coupling 102 is in use within the pump assembly 20, the distal end 102b of the coupling 102 is spaced apart from the proximal end 102a thereof along the drive axis A. In examples, the proximal end 102a of the coupling 102 may define a proximal opening 104. The proximal opening 104 of the coupling 102 may be configured to receive at least a portion of the input drive shaft 46 of the pump 40 therein, as may be seen in FIG. 9 and FIG. 10. The distal end 102b of the coupling 102 may, in certain examples, define a distal opening 106. The distal opening 106 of the coupling 102 may be configured to receive at least a portion of the output drive shaft 66 of the motor drive unit 60 therein, as may be seen in FIG. 9 and FIG. 10. In this way, the coupling 102 may operatively connect the output drive shaft 66 and the pump 40, namely the input drive shaft 46 thereof.

The coupling 102 may generally transfer rotational motion from the output drive shaft 66 of the drive motor unit 60 to the input drive shaft 46 of the pump 40 to attain a desired pump rotational speed. As may be seen with reference back to FIG. 9, the coupling 102 may operatively connect the output drive shaft 66 and the pump 40, namely the input drive shaft 46 of the pump 40. In this way, the output drive shaft 66 and the input drive shaft 46 may remain spaced apart from one another along the drive axis A (i.e., without directly contacting one another). This may advantageously reduce, minimize, or inhibit heat from passing through the output drive shaft 66 to the input drive shaft 46. For example, heat passing through the output drive shaft 66 may travel through and be dissipated from the coupling 102, rather than traveling through to the input drive shaft 46.

In examples, the coupling 102 may comprise elements that are made of a material having a low thermal conductivity. In particular, the coupling may include one or more insulating elements 110 therein. The insulating element(s) 110 may have a low thermal conductivity. In some examples, the insulating element(s) 110 may be a thermoplastic insulating element. By way of non-limiting example, the insulating element may be made of polyether ether ketone (PEEK), polyphenylene sulfide (PPS), fiberglass, or combinations thereof. The insulating element(s) 110 of the coupling 102 may, in certain examples, operate as bearings. In the example illustrated in FIG. 12A and FIG. 12B, the coupling 102 includes four insulating elements 110. However, it is to be understood that the coupling 102 may be designed with any number of insulating elements 110. For example, the coupling 102 could include one insulating element, two insulating elements, three insulating elements, four insulating elements, or more than four insulating elements.

In examples, the coupling 102 may include a first side member 114, a second side member 116, and an intermediate member 112. The intermediate member 112 may be positioned between the first and second side members 114, 116. The first side member 114 may be at the proximal end 102a of the coupling 102, and the second side member 116 may be at the distal end 102b of the coupling 102. Thus, when the coupling 102 is in use within the pump assembly 20, the first side member 114 of the coupling 102 may be spaced apart from the second side member 116 of the coupling 102 along the drive axis A. The first side member 114 may define the proximal opening 104 therein. The second side member 116 may define the distal opening 116 therein. The intermediate member 112 may include the one or more insulating members 110 disposed therein.

The first side member 114 of the coupling 102 may include at least one engagement feature 114a. The engagement feature 114a of the first side member 114 may be in the form of a projection extending outwardly from the first side member 114 in a first axial direction that is parallel to the drive axis A. The second side member 116 of the coupling 102 may also include at least one engagement feature 116a. The engagement feature 116a of the second side member 116 may be in the form of a projection extending outwardly from the second side member 116 in a second axial direction, opposite the first axial direction. Put another way, the engagement feature 114a of the first side member 114 and the engagement feature 116a of the second side member 116 may extend toward one another. In the example illustrated in FIG. 12A and FIG. 12B, the first side member 114 includes two engagement features 114a, and the second side member 116 includes two engagement features 116a, though it will be understood that, in alternative examples, the first and second side members 114, 116 may be designed with any number of engagement features. In the example illustrated in FIG. 12A and FIG. 12B, the engagement feature(s) 114a of the first side member 114 may extend along the first side member 114 in a first radial direction and the engagement feature(s) 116a of the second side member 116 extend along the second side member 116 in a second radial direction. The first radial direction can be substantially perpendicular to the second radial direction.

The intermediate member 112 defines receiving features configured to interface with the engagement features of the first and second side members 114, 116. For instance, in the example illustrated in FIG. 12A and FIG. 12B, the intermediate member 112 defines a first receiving feature 112a configured to interface with the engagement feature 114a of the first side member 114 and a second receiving feature 112b configured to interface with the engagement feature 116a of the second side member 116. The receiving features of the intermediate member 112 may be in the form of slots or recesses that extend into the intermediate member 112. In particular, the first receiving feature 112a may be in the form of an elongate slot extending into a first face of the intermediate member 112 in the second axial direction, and the second receiving feature 112b may be in the form of an elongate slot extending into an opposite second face of the intermediate member 112 in the first axial direction. Put another way, the first and second receiving features 112a, 112b of the intermediate member 112 may extend toward one another. In the example illustrated in FIG. 12A and FIG. 12B, the first receiving feature 112a of the intermediate member 112 may be elongate along the first radial direction, and the second receiving feature 112b of the intermediate member 112 may be elongate along the second radial direction.

The first engagement feature 114a and the first receiving feature 112a can have corresponding keyed shapes. The keyed shapes can be configured such that, when the first engagement feature 114a is engaged with the first receiving feature 112a, the first engagement feature 114a and the first receiving feature 112a are prevented from translating relative to one another along the axial direction. In some examples, the keyed shapes can be configured such that, when the first engagement feature 114a is engaged with the first receiving feature 112a, the first engagement feature 114a and the first receiving feature 112a are permitted to translate relative to one another along the first radial direction. In some examples, the keyed shapes can be configured such that the first engagement feature 114a and the first receiving feature 112a pivot relative to one another about an axis that extends along the first radial direction. Similarly, the second engagement feature 116a and the second receiving feature 112b can have corresponding keyed shapes. The keyed shapes can be configured such that, when the second engagement feature 116a is engaged with the second receiving feature 112b, the second engagement feature 116a and the second receiving feature 112b are prevented from translating relative to one another along the axial direction. In some examples, the keyed shapes can be configured such that, when the second engagement feature 116a is engaged with the second receiving feature 112b, the second engagement feature 116a and the second receiving feature 112b are permitted to translate relative to one another along the second radial direction. In some examples, the keyed shapes can be configured such that the second engagement feature 116a and the second receiving feature 112b pivot relative to one another about an axis that extends along the second radial direction. Such pivoting can compensate for misalignment between the output drive shaft 66 and the input drive shaft 46.

In some examples, each of the first and second receiving features 112a, 112b of the intermediate member may include one or more of the insulating elements 110 disposed therein. In the example illustrated in FIG. 12A and FIG. 12B, the first and second receiving features 112a, 112b of the intermediate member 112 each include two insulating elements 110 disposed therein. The insulating elements 110 disposed in the intermediate member 112 are generally disposed about a central opening 108 defined in the intermediate member 112.

Although the engagement features 114a, 116a of the first and second side members 114, 116 are illustrated as projections that interface with the recessed first and second receiving portions 112a, 112b of the intermediate member, it is to be understood that in alternative, non-depicted examples, these structures could be reversed. That is, it is contemplated that in such an alternative example, intermediate member 112 could include engagement features (e.g., in the form of projections extending outwardly therefrom) and the first and second side members 114, 116 could each include a receiving feature (e.g., in the form of a recess extending thereinto) configured to interface with a corresponding one of the engagement features of the intermediate member 112.

FIG. 13 is a schematic block diagram of a control system 130. The control system 130 may, in certain examples, be configured as a closed feedback loop for controlling aspects of operation of the at least one pump assembly 20. As may be seen in FIG. 13, the control system 130 includes at least one control unit 150 (e.g., a logic unit). In examples employing multiple pump assemblies 20a-n, the control unit 150 is electronically coupled to rotational sensor 68a, 68b . . . 68n. Each rotational sensor 68a, 68b . . . 68n may be coupled to a respective drive motor 62a, 62b . . . 62n. The rotational sensors may include rotational encoders, a Hall Effect sensor, and/or any device suitable for measuring rotation. In alternative examples, the control unit 150 may also be electronically coupled to each motor 62a, 62b . . . 62n. The control unit 150 may include one or more memories, one or more processors used to execute instructions stored in the memory, and/or input and output portions. The input and output portions may be typical transmit/receive devices suitable for transmitting signals to and/or receiving signals from other components of the control system 130.

In examples, the control system 130 may operate as a closed loop feedback to maintain pump speeds within a targeted operating range. The control unit 150 may have a target drive motor rotational speed (“target RPM”) set by an operator and/or stored in memory. The rotational sensor(s) may determine the actual drive motor rotational speed (“actual RPM”). The actual RPM may be sent to the control unit 150. Software executed by the control unit 150 may determines (1) if the actual RPM is different from the target RPM, and (2) the magnitude of variance (+/−) from the target RPM, if any. If the control unit 150 determines a variance between the target RPM and the actual RPM, the control unit 150 may transmit a signal to the motor(s) to increase or decrease the rotational speed until the actual RPM is consistent with the target RPM (within acceptable variances, such as within reasonable processing limits typical in metered applications). This feedback loop may be applied across each pump assembly installed on the applicator. In this way, the control system 130 may function to maintain the target rotation speed at the drive motor(s), which may resultantly maintain a consistent volumetric flow rate over time. This may advantageously limit processing drift that occurs gradually over time in conventional systems. In examples of the present disclosure, because each pump assembly is independently driven, the feedback loops for each pump assembly may help control individual pump outputs.

In examples, the at least one pump assembly 20 described herein may be independently controlled. For instance, control system 130 may be used to independently adjust the RPM of the drive motor unit 60. Changes in the drive motor RPM may vary the volumetric flow rate of the pump assembly 20, which varies the flow rate of adhesive (e.g., a hotmelt) exiting the dispensing module (e.g., via a nozzle). Accordingly, in certain examples, each stream of adhesive exiting the dispensing module may be individually controlled by adjusting the RPM of the corresponding drive motor unit 60. In examples, independent adjustment or control of the flow rate at the pump assembly 20 may thus be realized without having to change the pump. Furthermore, the at least one pump assembly 20 may have a wide range of flow rates for given range of RPM compared to conventional pumps used in conventional adhesive applicators. Put another way, the at least one pump assembly 20 described herein may have an effective operating range of two or more conventional pumps designed for adhesive applicators. In addition, such an operating range of the pump is possible in a compact size.

In conventional pumps used with hotmelt adhesives, it is necessary to change the pumps to vary the flow rate outside of the certain operating ranges. For example, one gear set within a pump may be designed for a range of flow rates given a set of input rotational speeds. To achieve higher flow rates (or lower flow rates), a different pump with a gear set designed for the higher (or lower) flow rates must be used. Table 1 below includes the volumetric flow rates in cubic centimeter per minute (cc/min) for a conventional small pump (“Pump 1”), a conventional large pump (“Pump 2”), and the pump assembly 20 described herein. Pump 1 in the table below has a cubic centimeter per revolution (cc/rev) of 0.16. Pump 2 in the table below has a cc/rev of 0.786. The “pump assembly” in the table below has a cc/rev of 0.34. Pump 1 and Pump 2 are representative of the smaller sized pumps and larger (or largest) sized pumps, respectively, used in conventional adhesive applicators. Pump 1 and Pump 2, by manufacturers design, are limited to 150 rpms. Exceeding manufacturers' rpm limits could cause mechanical damage, such as due to increased wear.

TABLE 1

| | Pump 1 | Pump 2 | Pump Assembly |
|---|---|---|---|
| RPM | (0.16 cc/rev) | (0.786 cc/rev) | (0.34 cc/rev) |
| 10 | 1.6 | 7.86 | 3.4 |
| 20 | 3.2 | 15.72 | 6.8 |
| 30 | 4.8 | 23.58 | 10.2 |
| 40 | 6.4 | 31.44 | 13.6 |
| 50 | 8 | 39.3 | 17 |
| 60 | 9.6 | 47.16 | 20.4 |
| 70 | 11.2 | 55.02 | 23.8 |
| 80 | 12.8 | 62.88 | 27.2 |
| 90 | 14.4 | 70.74 | 30.6 |
| 100 | 16 | 78.6 | 34 |
| 130 | 17.6 | 86.46 | 37.4 |
| 120 | 19.2 | 94.32 | 40.8 |
| 130 | 20.8 | 102.18 | 44.2 |
| 140 | 22.4 | 130.04 | 47.6 |
| 150 | 24 | 117.9 | 51 |
| 160 | | | 54.4 |
| 170 | | | 57.8 |
| 180 | | | 61.2 |
| 190 | | | 64.6 |
| 200 | | | 68 |
| 210 | | | 71.4 |
| 220 | | | 74.8 |
| 230 | | | 78.2 |
| 240 | | | 81.6 |
| 250 | | | 85 |
| 260 | | | 88.4 |
| 270 | | | 91.8 |
| 280 | | | 95.2 |
| 290 | | | 98.6 |
| 300 | | | 102 |

As can be seen in Table 1, the pump assembly 20 described herein has a wide range of volumetric flow rates for a given range of motor RPMs. For pump speeds of 10-150 rpm, the volumetric flow rate for Pump 1 ranges from 1.6 to 24 cc/min, and the volumetric flow rate for Pump 2 ranges from 7.86 to 117.9 cc/min. The pump assembly 20 described herein can provide a range of volumetric flow rates that encompasses the flow rates of two different conventional pumps, at a wide range of pump speeds. In other words, the pump assembly 20 described herein is operable to provide a volumetric flow rate that can conventionally can only be accomplished by employing two different pumps. This results in greater process flexibility because each pump assembly can be separately controlled to provide a targeted volumetric flow rate among a wider range of possible volumetric flow rates. Furthermore, this level of control, and possible variation, may be possible across multiple pumps and adhesive streams. Pump assembly 20 described herein may have rpms up to about 300 rpms. The increased rpm range (e.g., as compared to Pump 1 and Pump 2 described above, may permit pump assembly 20 to accomplish a wider flow range.

Furthermore, the pump assembly 20 described herein may offer more in-process flexibility. In conventional pumps used with hotmelt adhesives, the only way to change or adjust the RPM of the pumps was to the change the RPM of the common drive shaft driving each pump. Because a common drive shaft is used to drive the pumps, different pumps are used across the width of the applicator in order to vary the flow rate across the width of the applicator. Increasing (or decreasing) the RPM of the common drive shaft results in the same increase (or decrease) in flow rates across all of the pumps. Thus, conventional pumps designs limit the ability to adjust process parameters, such as volumetric flow rate across the width, in-line. Rather, to change flow rates outside the desirable operating ranges of the pumps installed on the machine, the pumps must be replaced with different pumps appropriately sized for the application. As discussed above, replacing typical pumps is time-intensive and complex. In contrast, the pump assembly 20 described herein allows for individual and independent pump control while also minimizing removal and/or replacement times.

There are several additional advantages to the pump assembly 20 described herein. As noted above, by using the pump assembly 20 described herein, volumetric displacement of each pump assembly within the adhesive applicator may be independently controlled. With independent displacement control of adjacent pumps along the applicator length, differential flow rates may be varied by changing the drive motor speed. Less pump assemblies are required for a wide range of processing needs (e.g., a wide range of flow rates). This may reduce the number of parts required and also assist in managing product changeover during use. In addition, by using the pump assembly 20 described herein, adhesive flow streams may be easily added or removed.

It should be noted that the illustrations and descriptions of the examples shown in the figures are for exemplary purposes only, and should not be construed as limiting the disclosure. One skilled in the art will appreciate that the present disclosure contemplates various examples. Additionally, it should be understood that the concepts described above with the above-described examples may be employed alone or in combination with any of the other examples described above. It should further be appreciated that the various alternative examples described above with respect to one illustrated example can apply to all examples as described herein, unless otherwise indicated. While the above-described nozzles, applicators, and dispensing systems are described with reference to fluids, it is to be understood that a wide variety of fluids and that, in addition or alternatively thereto, a wide variety of materials can likewise be used.

Unless explicitly stated otherwise, each numerical value and range should be interpreted as being approximate as if the word “about,” “approximately,” or “substantially” preceded the value or range. The terms “about,” “approximately,” and “substantially” can be understood as describing a range that is within 15 percent of a specified value unless otherwise stated.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include these features, elements and/or steps. The terms “comprising,” “including,” “having,” and the like are synonymous and are used inclusively, in an open-ended fashion, and do not exclude additional elements, features, acts, operations, and so forth.

While certain examples have been described, these examples have been presented by way of example only and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various examples of the present invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

It will be understood that reference herein to “a” or “one” to describe a feature such as a component or step does not foreclose additional features or multiples of the feature. For instance, reference to a device having or defining “one” of a feature does not preclude the device from having or defining more than one of the feature, as long as the device has or defines at least one of the feature. Similarly, reference herein to “one of” a plurality of features does not foreclose the invention from including two or more, up to all, of the features. For instance, reference to a device having or defining “one of a X and Y” does not foreclose the device from having both the X and Y.

What is claimed:

1. A pump assembly configured to connect to a manifold of an applicator for dispensing hotmelt adhesive, the pump assembly comprising:
an inlet for receiving a hotmelt adhesive and an outlet in fluid communication with the manifold;
a pump;
a drive motor unit operable for pumping the hotmelt adhesive from the inlet to the outlet, the drive motor unit including an output drive shaft connected to the pump and a drive motor configured to rotate the output drive shaft about a drive axis; and
a thermal isolation region between the pump and the drive motor, the thermal isolation region including:
an isolation plate formed from a thermally insulating material; and
a thermal isolation frame having a first end and a second end offset from one another along the drive axis, the thermal isolation frame defining a hollow interior between the first and second ends that is configured to permit airflow between the first and second ends.

2. The pump assembly of claim 1, wherein the first end of the frame is coupled to the pump and the second end of the frame is coupled to the isolation plate.

3. The pump assembly of claim 1, wherein each of the first end and the second end of the thermal isolation frame define a shape of a plate.

4. The pump assembly of claim 1, wherein the frame defines a plurality of side walls that extend between the first end and the second end, and the hollow interior is defined between the plurality of side walls.

5. The pump assembly of claim 4, wherein each of the plurality of side walls defines a shape of a plate.

6. The pump assembly of claim 4, wherein each of the plurality of side walls has a cross-sectional dimension of from 0.040 to about 0.10 inches and the frame is configured to withstand torques of about 4 N·m and greater imparted by the drive motor unit.

7. The pump assembly of claim 1, wherein the first end of the frame defines a first surface against which the proximal end of the cooling sleeve abuts and the second end of the frame defines a second surface against which the thermal isolation plate abuts, and wherein a distance between the first and second ends is from about 0.7 to about 2.5 or more inches.

8. The pump assembly of claim 1, further comprising a cooling sleeve having a proximal end and an open distal end offset from one another along the drive axis, the open distal end of the cooling sleeve at least partially surrounding the drive motor unit.

9. The pump assembly of claim 1, wherein the pump is disposed within a pump housing and the drive axis extends through the drive motor and the pump housing such that the drive motor and the pump housing are aligned with one another along the drive axis.

10. An applicator for dispensing hotmelt adhesive, comprising:
a manifold;
a dispensing module coupled to the manifold; and
the pump assembly of claim 1, wherein the pump assembly is configured to removably couple to the manifold.

11. A pump assembly configured to connect to a manifold of an applicator for dispensing hotmelt adhesive, the pump assembly comprising:
an inlet for receiving a hotmelt adhesive and an outlet in fluid communication with the manifold;
a pump;
a drive motor unit operable for pumping the hotmelt adhesive from the inlet to the outlet, the drive motor unit including an output drive shaft connected to the pump and a drive motor configured to rotate the output drive shaft about a drive axis; and
a thermal isolation region between the pump and the drive motor, the thermal isolation region including at least one thermal isolation body and a cooling sleeve, the cooling sleeve having a proximal end and an open distal end spaced apart from the proximal end along the drive axis, the open distal end of the cooling sleeve at least partially surrounding the drive motor unit.

12. The pump assembly of claim 1, wherein the cooling sleeve surrounds a proximal end portion of the drive motor unit so as to define an air flow passage between the proximal end portion of the drive motor unit and a circumferential inner surface of the cooling sleeve.

13. The pump assembly of claim 12, wherein the cooling sleeve defines:
an air inlet in fluid communication with the air flow passage;
at least one air outlet at the distal end of the cooling sleeve and in fluid communication with the air flow passage.

14. An applicator for dispensing hotmelt adhesive, comprising:
a manifold;
a dispensing module coupled to the manifold; and
the pump assembly of claim 11, wherein the pump assembly is configured to removably couple to the manifold.

15. A pump assembly configured to connect to a manifold of an applicator for dispensing hotmelt adhesive, the pump assembly comprising:
an inlet for receiving a hotmelt adhesive and an outlet in fluid communication with the manifold;
a pump;
a drive motor unit operable for pumping the hotmelt adhesive from the inlet to the outlet, the drive motor unit including an output drive shaft and a drive motor configured to rotate the output drive shaft; and
a coupling operatively connecting the pump and the output drive shaft, the coupling including at least one insulating element therein.

16. The pump assembly of claim 15, wherein:
the coupling has a proximal end and an opposite, distal end;
the proximal end defines a proximal opening configured to receive at least a portion of an input drive shaft of the pump therein; and
the distal end defines a distal opening configured to receive at least a portion of the output drive shaft therein.

17. The pump assembly of claim 16, wherein the coupling comprises:
a first side member at the proximal end thereof and defining the proximal opening therein;
a second side member at the distal end thereof and defining the distal opening therein; and
an intermediate member positioned between the first and second side members, the intermediate member including the at least one insulating element disposed therein.

18. The pump assembly of claim 15, wherein the at least one insulating element includes a plurality of insulating elements and the coupling comprises:
a first side member including at least one engagement feature extending outwardly from the first side member in a first direction;
a second side member including at least one engagement feature extending outwardly from the second side member in a second direction opposite the first direction; and
an intermediate member positioned between the first and second side members, the intermediate member including a first receiving feature configured to interface with the engagement feature of the first side member and a second receiving feature configured to interface with the engagement feature of the second side member, each of the first and second receiving features of the intermediate member including one of the plurality of insulating elements disposed therein.

19. The pump assembly of claim 15, wherein the at least one insulating element is a thermoplastic insulating element.

20. An applicator for dispensing hotmelt adhesive, comprising:
a manifold;
a dispensing module coupled to the manifold; and
the pump assembly of claim 15, wherein the pump assembly is configured to removably couple to the manifold.
